(19) United States
(12) Patent Application Publication
(10) Pub. No.: US 2013/0001181 A1
(43) Pub. Date: Jan. 3, 2013

(54) SYSTEM FOR MOVING A LOAD

(75) Inventor: Kai Wegener, Munich (DE)

(73) Assignee: KRONES AG, Neutraubling (DE)

(21) Appl. No.: 13/535,457

(22) Filed: Jun. 28, 2012

(30) Foreign Application Priority Data
Jun. 29, 2011 (DE) 10 2011 078 310.5

(51) Int. Cl. B66C 13/06; B66C 19/00

(52) U.S. Cl. 212/273

(57) ABSTRACT

A system for moving a load includes a load carrier, a running rail, a traveling crab configured to move the load carrier along the running rail, a lifting device connecting the load carrier to the traveling crab and configured to move the load carrier upwardly and downwardly, and a bracing device configured to brace the load carrier.

### CROSS REFERENCE TO RELATED APPLICATIONS

This application claims priority to German Patent Application No. DE 10 2011 078 310.5, filed Jun. 29, 2011, which is hereby incorporated by reference herein in its entirety.

### BACKGROUND

Systems for moving loads are widely used, e.g. in industry, construction or warehousing, here in particular in the form of aisle stackers. Conventional aisle stackers of this type may be formed of masts which travel through aisles on a support rail. A load carrier is vertically movable on such a mast.

Such a conventional aisle stacker has certain drawbacks, for example, a very high driving power. Therefore, it is more appropriate to replace the masts by ropes.

DE 101 22 142 A1 describes an apparatus where the load carrier is suspended on a plurality of supporting ropes on the traveling crab. Such an apparatus has the disadvantage, however, that the load carrier hangs freely on the traveling crab and can thus be deflected by its inertia out of its balanced position when the traveling crab moves. Such a swinging movement results in longer process times when the load is picked up and put down as the load carrier has to come to rest first in order to head for a position with sufficient precision to pick up and put down the load.

DE 10 2009 050 729 A1 describes a rope robot for mounting large-scale assemblies on site, with the load hanging freely on four ropes. Also, rope robots of the Fraunhofer-Institut für Produktionstechnik and Automatisierung IPA are known, however, which additionally have four ropes bracing the load carrier in a downward direction. However, such a system comprises a total of eight ropes with at least one drive each, so that the control of such a system is complicated.

### SUMMARY

In an embodiment, the present invention provides a system for moving a load including a load carrier, a running rail, a traveling crab configured to move the load carrier along the running rail, a lifting device connecting the load carrier to the traveling crab and configured to move the load carrier upwardly and downwardly, and a bracing device configured to brace the load carrier.

### BRIEF DESCRIPTION OF THE DRAWINGS

Exemplary embodiments are described in more detail below with reference to the drawings, in which:

FIG. 1a schematically shows a perspective view of a system for the movement of loads, comprising two bracing elements;

FIG. 1b schematically shows the horizontal components of the force vectors in the case of two bracing forces;

FIG. 2a schematically shows a perspective view of a system for the movement of loads, comprising four bracing elements;

FIG. 2b schematically shows the horizontal components of the force vectors in the case of four bracing forces;

FIG. 3 schematically shows a front elevation of a system for the movement of loads longitudinally to the running rail;

FIG. 4a schematically shows a front elevation of a system for the movement of loads transversely to the running rail;

FIG. 4b schematically shows a front elevation of an alternative embodiment of the system for the movement of loads transversely to the running rail.

### DETAILED DESCRIPTION

In an embodiment, the present invention provides a system for the movement of loads by means of a simple control mechanism.

In an embodiment, the present invention provides a system for moving a load, comprising a load carrier, a running rail with a traveling crab for moving the load carrier along the running rail, a lifting device for moving the load carrier upwardly and downwardly, wherein the load carrier is connected to the traveling crab by the lifting device, as well as a bracing device for bracing the load carrier.

The system is specifically usable as an aisle stacker or shelf access equipment, wherein the load carrier (load handling device) serves to pick up a load, e.g. articles in stock. To this end, the load carrier may comprise a plate and/or a basket and/or a tub. By means of the traveling crab and the lifting device the load carrier can be moved precisely to a desired position in an aisle. Specifically, the running rail can run horizontally, wherein the traveling crab can adopt a horizontal position independently of a vertical position, while the lifting device can adopt a vertical position independently of a horizontal position. A desired position can also be adopted directly by driving the traveling crab and the lifting device in parallel.

The load carrier can comprise additional elements such as grippers, prongs, rails, chains, belts and/or rollers, to pick up or put down the load.

The running rail can comprise a beam, specifically a T-beam or an H-beam. The system can also comprise several running rails. Specifically, several running rails may be arranged at the same height so as to distribute the weight of the load carrier and the load to several rails.

The traveling crab may comprise rollers by means of which it is movable along the running rail. The traveling crab may comprise a drive, specifically a motor, specifically an electric motor, and/or be connected via a gear and/or a shaft and/or a circulating belt and/or a circulating rope to a drive spaced apart from the traveling crab. The traveling crab may also comprise several drives. The traveling crab may also comprise one or more brakes and/or locking devices so as to lock the traveling crab in one position on the running rail. The system may also comprise several traveling crabs which are arranged on the same running rail or different running rails.

The bracing device may brace the load carrier specifically in a downward direction. By bracing the load carrier a deflection of the load carrier out of its equilibrium by its own inertia, specifically if the load carrier is accelerated or decelerated, and/or by external forces can be prevented. Thus, a process time for picking up or putting down load can be reduced.

The bracing device may comprise a bracing element which is connected to the load carrier and can be tightened so as to brace the load carrier. The system may also comprise several, specifically two, three or four bracing elements.

The bracing device can comprise a tightening device and a bracing element linkage, wherein the tightening device and the bracing element linkage are connected to the bracing element, wherein the bracing element can be tightened by varying the length of the bracing element between the tightening device and the bracing element linkage by means of the tightening device. Specifically, the tightening device is adapted to tighten the bracing element.

The length of the bracing element between the tightening device and the bracing element linkage designates in this case the length of the bracing element between the points where this bracing element leaves the tightening device and/or the bracing element linkage. Specifically, portions of the bracing element wound up in and/or on the tightening device and/or bracing element linkage do not belong to said length.

The bracing device can subject the bracing element linkage to a bracing force, wherein the bracing force is transferred by the bracing element. Specifically, the bracing force can act on the bracing element linkage by exerting tension on the tightening device by means of the bracing element.

The tightening device and/or the bracing element linkage may be arranged underneath the load carrier, specifically on the floor, on a rack and/or on a rail, and/or on the load carrier, specifically on the side walls and/or bottom side thereof.

Specifically, the tightening device may be connected on the floor, on a rack on and/or above the floor and/or on a rail on and/or above the floor. The bracing element linkage can then be arranged on the load carrier. This has the advantage that the weight of the load carrier with the picked up load is not increased by the weight of the tightening device, so that driving energy is saved.

Alternatively, the tightening device may be arranged on and/or underneath the load carrier, and the bracing element linkage on the floor, a rack on and/or above the floor and/or on a rail on and/or above the floor. This is advantageous if the tightening device tightens several bracing elements in parallel, so that driving energy can be saved.

The bracing element linkage and/or the tightening device may also be spaced apart from the load carrier and the floor, from the rack and/or the rail.

The tightening device and/or the bracing element linkage may be stationary, specifically on the floor and/or on a rack, or movable, specifically along a rail.

The bracing element linkage may be arranged on and/or underneath the load carrier, while the tightening device is movable on a second rail in parallel to and underneath the running rail, and underneath the load carrier. The tightening device and the traveling crab may then move synchronously, so that the load carrier always remains braced during movement. In this way it is possible to operate, for example, several stacked systems for moving a load. Specifically, the rail of a first system may simultaneously be the running rail of a second system.

The lifting device may comprise a carrying element, wherein the carrying element is connected to the traveling crab and/or the load carrier. The carrying element may connect the traveling crab to the load carrier. Specifically, the load carrier can hang on the traveling crab by means of the carrying element.

The lifting device may comprise a height-adjusting device and a carrying element linkage, wherein the length of the carrying element between the height-adjusting device and the carrying element linkage is adjustable by means of the height-adjusting device.

The length of the carrying element between the height-adjusting device and the carrying element linkage designates in this case the length of the carrying element between the points where this carrying element leaves the height-adjusting device and/or the carrying element linkage. Specifically, portions of the carrying element wound up in and/or on the height-adjusting device and/or the carrying element linkage do not belong to said length.

The height-adjusting device can subject the carrying element linkage to a carrying force, wherein the carrying force is transferred by the carrying element. Specifically, the carrying force can act on the carrying element linkage by exerting tension on the height-adjusting device by means of the carrying element.

The height-adjusting device and/or the carrying element linkage may be arranged on the traveling crab and/or on the load carrier, specifically on the upper side thereof. Specifically, either the carrying element linkage may be connected to the load carrier and the height-adjusting device may be connected to the traveling crab, or the carrying element linkage may be connected to the traveling crab and the height-adjusting device may be connected to the load carrier. The height-adjusting device and/or the carrying element linkage may also be spaced apart from the traveling crab and the load carrier.

The bracing element and/or the carrying element may comprise a rope, a ribbon and/or a chain. The bracing element and/or the carrying element may comprise textile fibers, plastic fibers and/or metal fibers.

The bracing element and/or the carrying element may comprise an inelastic and/or elastic material and/or a spring. Inelastic materials may have an elasticity module of more than 1 kNmm-2, specifically more than 10 kNmm-2, specifically more than 50 kNmm-2, specifically more than 100 kNmm-2. The bracing element and/or the carrying element may comprise a material or a spring whose limit of elasticity is not exceeded during the operation of the system. An elastic material, e.g. rubber, and/or a spring are advantageous if the bracing device or the height-adjusting device are to be waived, so that further driving energy can be saved.

If the carrying element comprises, for example, an elastic material and/or a spring, the load carrier can be moved upwardly and downwardly by reducing or increasing the length of the bracing element between the tightening device and the bracing element linkage, in combination with the restoring force of the carrying element. The height-adjusting device can then be waived.

If the bracing element comprises an elastic material and/or a spring, however, the bracing element is tightened by the restoring force thereof, thereby bracing the load carrier. The tightening device can then be waived.

The bracing element linkage and/or the carrying element linkage may comprise a fixing element, specifically a hook, a loop and/or a lug, and/or a deflection element, specifically a deflection roller, a holder and/or a lug.

Specifically, if the bracing element and/or the carrying element are ropes, these may comprise a loop on the bracing element linkage and/or the carrying element linkage, which may be engaged into a hook or encloses a lug. However, other fixing mechanisms are possible as well, e.g. by means of screwing, riveting and/or welding.

The bracing element and/or the carrying element, specifically a rope, may also be connected to the bracing element linkage and/or the carrying element linkage by means of a roller, specifically a deflection roller, and/or may be deflected on the bracing element linkage and/or the carrying element linkage by a lug. If the bracing element and/or the carrying element comprise a chain, this chain may also be deflected on the bracing element linkage and/or the carrying element linkage by means of a toothed wheel.

The tightening device and/or the height-adjusting device may comprise a hoist or a winch. The tightening device and/or the height-adjusting device may also comprise several hoists or winches. The tightening device and/or the height-adjusting device may also comprise spindles, reels, drums or toothed wheels.

The hoist or winch may be self-winding. To this end, the hoist or winch may comprise a spring and/or a locking device. A self-winding hoist or winch is advantageous if the tightening device and/or the height-adjusting device do not have their own drive, so that additional driving power may be saved.

The bracing device and/or the lifting device may comprise a drive, specifically a motor. Specifically, the drive can drive the hoist or winch. Specifically, the motor can be an electric motor.

The bracing device and/or the lifting device may also be connected to a spaced apart drive by a gear or a shaft. The bracing device and/or the lifting device may also comprise a brake and/or a locking device. The bracing device and/or the lifting device may also comprise several drives. A driven bracing device and/or lifting device are advantageous if the load carrier is to be moved with precision and is not to be deflected out of its balanced position, specifically by a controlled increasing and/or reducing of the lengths of the bracing element between the tightening device and the bracing element linkage and/or the carrying element between the height-adjusting device and the carrying element linkage.

The drive may be controllable such that the bracing element always remains tightened during the operation of the system, specifically during movement of the load carrier. Specifically, the bracing element may always be tightened to the same extent. To this end, a hoist or winch may be driven by the drive.

If the load carrier is moved down, the drive can drive the hoist or winch such that the length of the bracing element between the tightening device and the bracing element linkage is reduced to such an extent that the bracing element remains tightened to the same extent, specifically does not sag. This can be obtained, for example, by winding up the bracing element in whole or in part.

If the load carrier is moved up, the drive can drive the hoist or winch such that the length of the bracing element between the tightening device and the bracing element linkage is increased to such an extent that the bracing element remains tightened to the same extent, specifically is not overtightened. This can be obtained, for example, by unwinding the bracing element in whole or in part.

The drive can be controllable such that the distance between the traveling crab and the load carrier is adjustable. Thus, an upward movement and downward movement of the load carrier can be obtained. Specifically, the drive can drive a hoist or winch for this purpose.

If the load carrier is moved down, the drive can drive the hoist or winch such that the length of the carrying element between the height-adjusting device and the carrying element linkage is increased. This can be obtained, for example, by unwinding the carrying element in whole or in part.

If the load carrier is moved up, the drive can drive the hoist or winch such that the length of the carrying element between the height-adjusting device and the carrying element linkage is reduced. This can be obtained, for example, by winding up the carrying element in whole or in part.

The bracing device may comprise a first and second bracing element for subjecting the load carrier to a corresponding first and second bracing force, wherein the horizontal component of the vector of the first bracing force defines with the horizontal component of the vector of the second bracing force an angle of more than 90°, specifically of 180°.

The horizontal component of a vector designates in this case the orthogonal projection of the vector on the horizontal plane which, again, is a vector. The angle between two vectors here always designates the smaller angle defined by the two vectors in the plane spanned by them. This angle is always between 0° and 180°, so that vectors at an angle of 0° are parallel, and are antiparallel at an angle of 180°.

The first and second bracing forces can each act on a first and second bracing element linkage by tightening a first and second tightening device by means of the first and second bracing element.

In the case of a movement of the load carrier the horizontal component of the vector of the first bracing force can define with the horizontal component of the velocity vector of the load carrier an angle of less than 90°, specifically of 0°, while the horizontal component of the vector of the second bracing force defines with the horizontal component of the velocity vector of the load carrier an angle of more than 90°, specifically of 180°.

As the load carrier is at rest, the horizontal components of the first and second bracing forces can vectorially add up to zero. During a movement of the load carrier the horizontal components of the first and second bracing forces can vectorially add up to non-zero and act such that the load carrier can be moved in the direction of movement, i.e. along the straight line spanned by the velocity vector of the load carrier, with a positive or negative acceleration or at a constant speed.

The bracing device can comprise two ropes each bracing the load carrier in two opposite directions. The ropes may be connected to the floor, specifically by a respective tightening device.

The bracing device may comprise a first, second and third bracing element for subjecting the load carrier to a corresponding first, second and third bracing force, wherein the horizontal component of the vector of the first bracing force defines with the horizontal components of the vectors of the second and third bracing forces an angle of more than 90°.

The first, second and third bracing forces can each act on a first, second and third bracing element linkage by exerting tension on a first, second and third tightening device by means of the first, second and third bracing element.

If the load carrier moves, the horizontal component of the vector of the first bracing force can define with the horizontal component of the velocity vector of the load carrier an angle of less than 90°, specifically of 0°, or of more than 90°, specifically 180°, while the horizontal components of the vectors of the second and third bracing forces each define with the horizontal component of the velocity vector of the load carrier an angle of more than 90°, specifically of 180°, or of less than 90°, specifically 0°. Specifically, the vectorial sum of the horizontal components of the vectors of the second and third bracing forces can define with the horizontal component of the velocity vector of the load carrier an angle of more than 90°, specifically of 180°, or of less than 90°, specifically 0°.

As the load carrier is at rest, the horizontal components of the first, second and third bracing forces can vectorially add up to zero. During a movement of the load carrier the horizontal components of the first, second and third bracing forces can vectorially add up to non-zero and act such that the load carrier can be moved in the direction of movement, i.e. along the straight line spanned by the velocity vector of the load carrier, with a positive or negative acceleration or at a constant speed.

The bracing device can comprise three ropes each bracing the load carrier in a downward direction, specifically in two or three different directions. The ropes may be connected to the floor, specifically by a respective tightening device.

The bracing device may comprise a first, second, third and fourth bracing element for subjecting the load carrier to a corresponding first, second, third and fourth bracing force, wherein the horizontal components of the vectors of the first and second bracing forces define with the horizontal components of the vectors of the third and fourth bracing forces an angle of more than 90°.

The first, second, third and fourth bracing forces can each act on a first, second, third and fourth bracing element linkage by exerting tension on a first, second, third and fourth tightening device by means of the first, second, third and fourth bracing element.

If the load carrier moves, the horizontal components of the vectors of the first and second bracing forces can define with the horizontal component of the velocity vector of the load carrier an angle of less than 90°, specifically of 0°, while the horizontal components of the vectors of the second and third bracing forces each define with the horizontal component of the velocity vector of the load carrier an angle of more than 90°, specifically of 180°. Specifically, the vectorial sum of the horizontal components of the vectors of the first and second bracing forces can define with the horizontal component of the velocity vector of the load carrier an angle of less than 90°, specifically of 0°, while the vectorial sum of the horizontal components of the vectors of the third and fourth bracing forces define with the horizontal component of the velocity vector of the load carrier an angle of more than 90°, specifically 180°.

As the load carrier is at rest, the horizontal components of the first, second, third and fourth bracing forces can vectorially add up to zero. During a movement of the load carrier the horizontal components of the first, second, third and fourth bracing forces can vectorially add up to non-zero and act such that the load carrier can be moved in the direction of movement, i.e. along the straight line spanned by the velocity vector of the load carrier, with a positive or negative acceleration or at a constant speed.

The bracing device can comprise four ropes each bracing the load carrier in a downward direction, specifically in two, three or four different directions. The ropes may be connected to the floor, specifically by a respective tightening device.

In principle, the bracing device may also comprise more than four bracing elements in correspondence with the above description.

The running rail may be a first running rail, and the system may comprise a second running rail, wherein the load carrier is arranged underneath the first and above the second running rail, the second running rail comprising a runner, wherein the bracing device is connected to the runner, wherein the runner is always underneath the traveling crab during the operation of the system, specifically during the movement of the traveling crab. Specifically, the traveling crab and the runner may move synchronously.

The lifting device may comprise at least two carrying elements each with a height-adjusting device and a carrying element linkage. The height-adjusting devices and/or the carrying elements can be connected to the same or to two different traveling crabs which, in turn, are movable along the same running rail or two different running rails. A system comprising two running rails each with a traveling crab, each of which is connected to a height-adjusting device and/or a carrying element, is particularly advantageous if the load moved is very heavy, as the weight of the load carrier and the load received in the load carrier can be distributed to both running rails.

In operation of the apparatus, specifically during a vertical movement of the load carrier, the first and second height-adjusting devices can each adjust the lengths of the first and second carrying elements between the first and second height-adjusting devices and first and second carrying element linkages such that the load carrier is either not deflected out of its balanced position or is inclined by a specific angle. An inclination about a specific angle is advantageous because it may facilitate picking up and/or putting down a load.

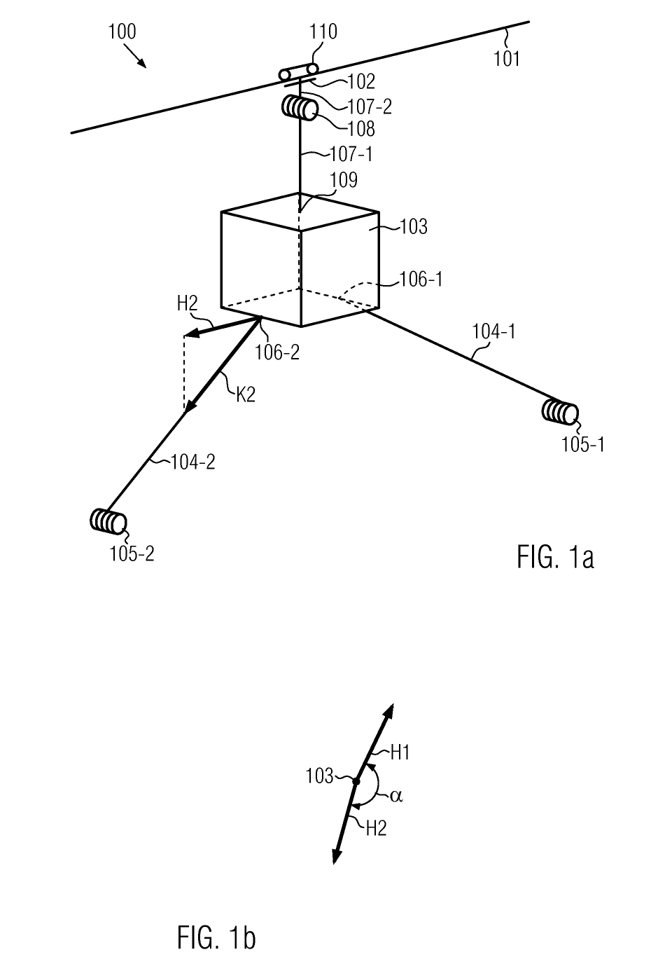

FIG. 1a shows a perspective view of a system 100 for moving loads. The system 100 comprises a, specifically horizontal, running rail 101 along which a traveling crab 102 can be moved. To this end, the traveling crab comprises a drive 110 and rollers. A load carrier or load handling device 103 hangs underneath the traveling crab 102 and is braced by means of bracing elements 104.

In this example, the system comprises two bracing elements 104-1 and 104-2. The first bracing element 104-1 is connected to a first tightening device 105-1 and to a first bracing element linkage 106-1. The second bracing element 104-2 is connected to a second tightening device 105-2 and to a second bracing element linkage 106-2.

The tightening devices 105 are, in this case, mounted underneath the load carrier, e.g on the floor. Specifically, the tightening devices 105 are placed at the same height.

The bracing element linkages 106 are located on the sides and/or the bottom side of the load carrier 103. The bracing element linkages 106 are, in this case, formed of the attachments of the bracing elements 104 on the load carrier 103. To this end, the bracing element linkages 106 can comprise, for example, lugs to which the bracing elements 104 are fixed by means of loops or hooks.

During the operation of the system 100, specifically during the movement of the load carrier 103, the load carrier 103 is always braced in a downward direction. To this end, the tightening devices 105 are controlled such that the bracing elements 104 between the tightening devices 105 and the bracing element linkages 106 remain always braced.

If the load carrier 103 moves, for example, horizontally in the direction of the first tightening device 105-1, the first tightening device 105-1 reduces the length of the first bracing element 104-1 between the first tightening device 105-1 and the first bracing element linkage 106-1. This reduction can also be obtained by winding up the first bracing element in whole or in part by means of a hoist or winch. In return, the second tightening device 105-2 increases the length of the second bracing element between the second tightening device 105-2 and the second bracing element linkage 106-2. This increase can be obtained by unwinding the second bracing element 104-2 in whole or in part by means of a hoist or winch. The hoists or winches of the tightening devices 105-1 and 105-2 can be driven by a motor.

The bracing elements 104, tightening devices 105 and bracing element linkages 106 together form the bracing device of system 100. The bracing device may comprise further elements, in particular brakes, springs and/or locking devices.

In the present case, the load carrier 103 hangs underneath the traveling crab 102 on a carrying element 107, which is connected to the carrying crab 102 and the load carrier 103. The carrying element 107 is connected to a height-adjusting device 108 and a carrying element linkage 109. In this example, the height-adjusting device 108 hangs on a second part 107-2 of the carrying element 107, while the load carrying element hangs on a first part 107-1 of the carrying element on the height-adjusting device. It is also possible, however, that the height-adjusting device 108 is directly connected to the traveling crab 102.

The height-adjusting device 108 allows adjusting the vertical position of the load carrier. If the load carrier 103 is to be moved upwards, the height-adjusting device 108 reduces the length of the first carrying element 107-1 between the height-adjusting device 108 and the carrying element linkage 109. This reduction can be obtained by winding up the first carrying element 107-1 in whole or in part by means of a hoist or winch. If the load carrier is to be moved downwards, however, the height-adjusting device 108 increases the length of the first carrying element 107-1 between the height-adjusting device 108 and the carrying element linkage 109. This increase can be obtained by unwinding the first carrying element 107-1 in whole or in part by means of a hoist or winch. The hoist or winch may be driven by a motor.

The carrying elements 107, the height-adjusting device 108 and the carrying element linkage 109 form the lifting device of the system 100. The lifting device may also comprise other elements, specifically brakes and/or springs and/or locking devices.

Even if the load carrier 103 makes, a vertical movement, the load carrier 103 remains braced in the downward direction. If the load carrier 103 moves, for example, upwards, the lengths of all bracing elements 104 between the tightening devices 105 and the bracing element linkages 106 are increased. If the load carrier 103 is moved downwards, however, the lengths of all bracing elements 104 between the tightening devices 105 and the bracing element linkages 106 are reduced. Increasing or reducing the lengths may be carried out in accordance with the description provided above.

The tightening devices 105 each subject the bracing element linkages 106 to a bracing force, which is transferred by means of the bracing elements 104. This example shows vector K2 of the second bracing force, which is applied by the tightening device 105-2 to the bracing element linkage 106-2 by means of the bracing element 104-2, and its horizontal component H2. The horizontal component H2 of vector K2 results from the orthogonal projection of vector K2 onto the horizontal plane.

FIG. 1b illustrates a top view of a simplified representation of system 100, wherein the load carrier 103 is simplified as a mass point. H1 and H2 each designate the horizontal component of the vectors of the first and second bracing forces acting on the load carrier 103. The horizontal components H1 and H2 act in different directions, specifically in opposite directions. Therefore, H1 and H2 define an angle of angle α greater than 90°. Specifically, an angle α of 180° is advantageous so as to ensure a maximum of stability of the load carrier 403. Moreover, it is advantageous if H1 is parallel to the horizontal component of a velocity vector of the load carrier 103, while H2 is anti-parallel to the horizontal component.

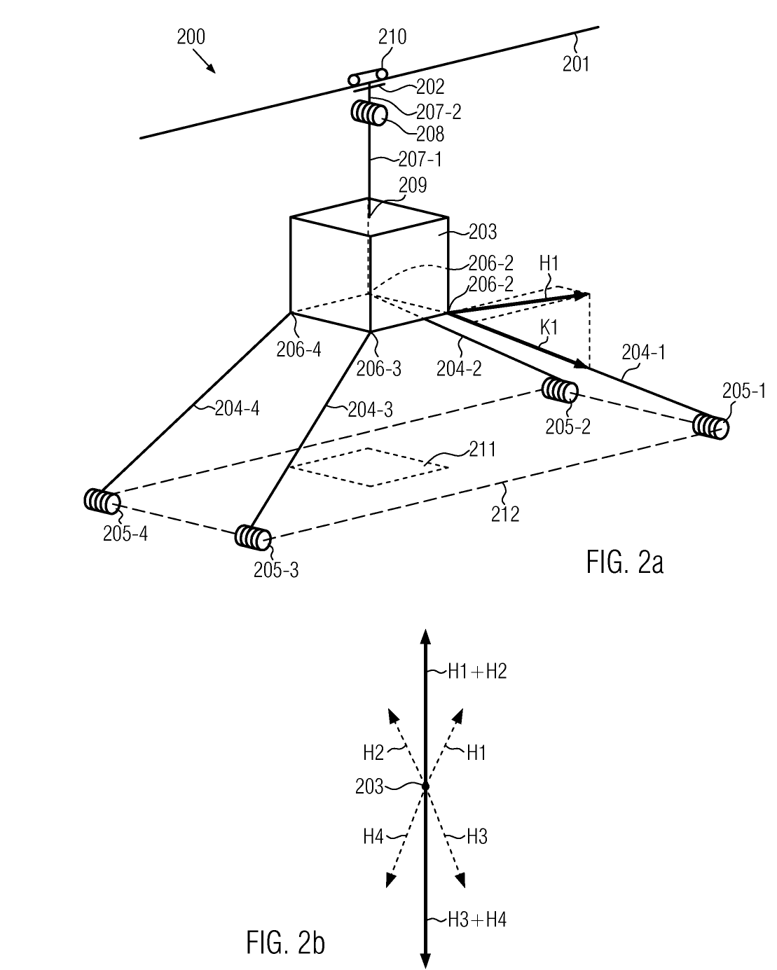

FIG. 2a shows a perspective view of a system 200 for the movement of loads differing from the preceding example in that the system comprises four bracing elements 204-1, 204-2, 204-3 and 204-4. The first bracing element 204-1 is connected to a first tightening device 105-1 and a first bracing element linkage 206-1. Analogously, the second 204-2, third 204-3 and fourth 204-4 bracing elements are each connected to the second 205-2, third 205-3 and fourth 205-4 tightening devices and second 206-2, third 206-3 and fourth 206-4 bracing element linkages.

In this case, it is advantageous if the tightening devices 205 are arranged underneath the load carrier 203 such that the orthogonal projection 211 of the load carrier 203 onto the plane defined by the tightening devices 205 is inside the surface 212 defined by the tightening devices 205.

If the load carrier 203 moves, for example, horizontally in the direction of the connecting line between the first 205-1 and second 205-2 tightening devices, the first 205-1 and second 205-2 tightening devices reduce the length of the first 204-1 and second 204-2 bracing elements between the first 205-1 and second 205-2 tightening devices and the respective first 206-1 and second 206-2 bracing element linkages. This reduction may be obtained by winding up the first 204-1 and second 204-2 bracing elements in whole or in part by means of a hoist or winch. In return, the third 205-3 and fourth 205-4 tightening devices increase the length of the third 204-3 and fourth 204-4 bracing elements between the third 205-3 and fourth 205-4 tightening devices and the respective third 206-3 and fourth 206-4 bracing element linkages. This increase can be obtained by unwinding the third 204-3 and fourth 204-4 bracing elements in whole or in part by means of a hoist or winch. The hoists or winches of the bracing devices 205-1 to 205-4 may here be driven by a motor.

The tightening devices 205 each subject the bracing element linkages 206 to a respective bracing force, which is transferred by means of the bracing elements 204. Vector K1 of the bracing force, which is applied by the tightening device 205-1 to the bracing element linkage 206-1 by means of the bracing element 204-1 is here drawn in by way of example. In this example, vector K1 has exactly one horizontal component H1 that corresponds to its orthogonal projection onto the horizontal plane.

FIG. 2b illustrates a top view of a simplified representation of system 200, wherein the load carrier 203 is simplified as mass point. H1, H2, H3 and H4 each designate the horizontal component of the vector of first, second, third and fourth bracing forces acting on the load carrier 203. The first and second bracing forces brace, in this case, the load carrier 203 in a first direction, and the third and fourth bracing forces brace the load carrier in a second direction. As to the angles between H1 and H2 each with H3 and H4 the requirements correspond to those of FIG. 1b.

As H1, H2 brace the load carrier 203 in a first direction, and H3, H4 in a second direction, the vectorial sums H1+H2 and H3+H4 point in different directions. It is advantageous if H1+H2 define with H3+H4 an angle of more than 90°, specifically of 180°. It is further advantageous if the vector H1+H2 is parallel to the horizontal component of a velocity vector of the load carrier 203, while the vector H3+H4 is antiparallel to the horizontal component of a velocity vector of the load carrier 603.

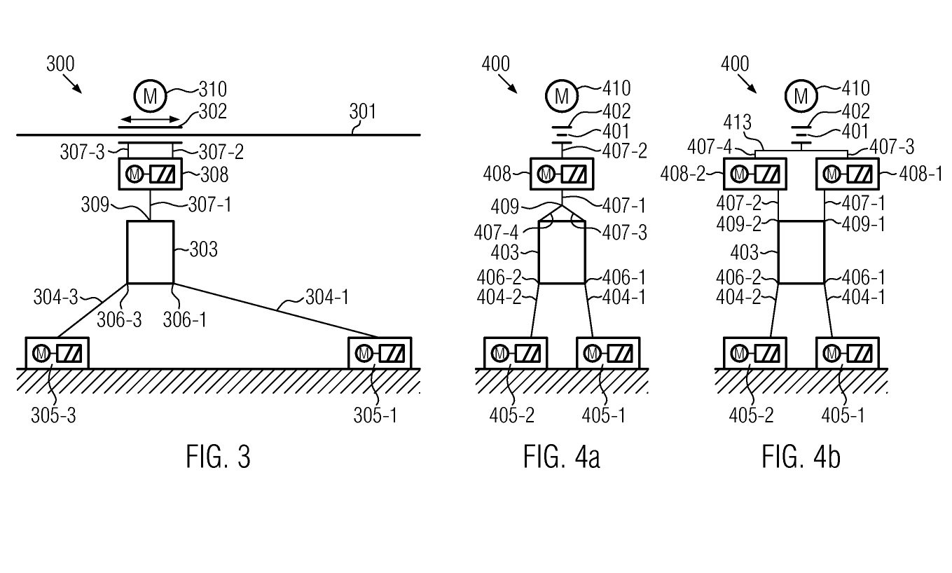

FIG. 3 shows a front elevation of a system 300 for the movement of loads along the running rail 301. A traveling crab 302 is movable along the running rail 301. A load carrier 303 hangs underneath the traveling crab 302. The load carrier 303 is braced downwardly by means of four bracing elements 304. A first 304-1 and third 304-3 bracing element are shown in this view. However, fewer bracing elements are feasible, specifically two or three, or more. The operating mode of the bracing device corresponds to the description of FIG. 2a.

The lifting device of system 300 comprises in this example, in addition to the height-adjusting device 308 and the carrying element linkage 309, a carrying element 307 including three parts 307-1 to 307-3. The load carrier 303 hangs on the first carrying element 307-1, which is connected to the load carrier 303 by the carrying element linkage 309 below and to the height-adjusting device 308 above, so that the load carrier 303 hangs on the height-adjusting device 308. The height-adjusting device 308 hangs on the traveling crab by means of a second 307-2 and third 307-3 carrying element.

FIG. 4a shows a front elevation of a system 400 for the movement of loads along the running rail 401. The present example differs from the previous embodiments in that the carrying element 407 comprises four parts 407-1 to 407-4. The height-adjusting device 408 hangs on the traveling crab 402 by means of a second carrying element 407-2. The first carrying element connects the carrying element linkage 409 to the height-adjusting device 408. In this example, the carrying element linkage 409 is spaced apart from the load carrier 403. The load carrier 403 is connected to the carrying element linkage 409 by means of a third 407-3 and fourth 407-4 carrying element. Also, it is possible that the load carrier 403 is connected to the carrying element linkage 409 by means of more than two carrying elements 407-3 and 407-4, specifically by means of three or four carrying elements.

FIG. 4b shows a front elevation of another system 400 for the movement of loads along the running rail 401. The present example differs from the previous embodiments in that the lifting device comprises two height-adjusting devices 408-1, 408-2 and two carrying element linkages 409-1, 409-2. The two height-adjusting devices 408-1, 408-2 are each connected to the respective carrying element linkages 409-1, 409-2 by means of a carrying element 407-1 and 407-2. The height-adjusting devices 408-1 and 408-2 each hang on a crossbar 413 by means of carrying elements 407-3 and 407-4, the crossbar 413 being connected to the traveling crab 402.

This embodiment has the advantage that the load carrier 403 can be deflected out of its balanced position in a controlled manner, for example, in order to facilitate picking up and/or putting down a load by a specific inclination. If it is desired to tilt the load carrier, for example, by a specific angle in the direction of the first height-adjusting device 408-1, the first height-adjusting device 408-1 reduces the length of the first carrying element 407-1 between the first height-adjusting device 408-1 and the first carrying element linkage 409-1, while the second height-adjusting device 408-2 increases the length of the second carrying element 407-2 between the second height-adjusting device 408-2 and the second carrying element linkage 409-2, wherein the load carrier 403 always remains braced in a downward direction by correspondingly increasing or reducing the lengths of the bracing elements 404 between the tightening devices 405 and the bracing element linkages 406.

While the invention has been particularly shown and described with reference to preferred embodiments thereof, it will be understood by those skilled in the art that various changes in form and details may be made therein without departing from the spirit and scope of the invention.

What is claimed is:

1: A system for moving a load, the system comprising:
a load carrier;
a running rail;
a traveling crab configured to move the load carrier along the running rail;
a lifting device connecting the load carrier to the traveling crab and configured to move the load carrier upwardly and downwardly; and
a bracing device configured to brace the load carrier.

2: The system recited in claim 1, wherein the bracing device includes a bracing element connected to the load carrier and configured to be tightened so as to brace the load carrier.

3: The system recited in claim 2, wherein the bracing device includes a tightening device and a bracing element linkage, the tightening device and bracing element linkage each being connected to the bracing element, wherein the bracing element is tightenable by varying a length of the bracing element, using the tightening device, between the tightening device and the bracing element linkage.

4: The system recited in claim 3, wherein at least one of the tightening device and bracing element linkage is disposed underneath the load carrier on at least one of a floor, a rack, a rail, a load carrier side wall, and a load carrier bottom side.

5: The system recited in claim 3, wherein at least one of the tightening device and bracing element linkage is stationary and disposed on at least one of a floor and a rack or is movable along a rail.

6: The system recited in claim 1, wherein the lifting device includes a carrying element, the carrying element being connected to at least one of the traveling crab and the load carrier.

7: The system recited in claim 6, wherein the lifting device includes a height-adjusting device and a carrying element linkage, the height adjusting device being configured to adjust a length of the carrying element between the height adjusting device and carrying element linkage.

8: The system recited in claim 7, wherein at least one of the height adjusting-device and carrying element linkage is disposed on at least one of the traveling crab and the load carrier.

9: The system recited in claim 1, wherein the bracing device includes a bracing element connected to the load carrier and configured to be tightened so as to brace the load carrier,
wherein the lifting device includes a carrying element, the carrying element being connected to at least one of the traveling crab and the load carrier, and
wherein at least one of the bracing element and carrying element includes at least one of a rope, a ribbon and a chain.

10: The system recited in claim 1, wherein the bracing device includes a bracing element connected to the load carrier and configured to be tightened so as to brace the load carrier,
wherein the lifting device includes a carrying element, the carrying element being connected to at least one of the traveling crab and the load carrier, and
wherein at least one of the bracing element and carrying element includes at least one of an inelastic material, an elastic material and a spring.

11: The system recited in claim 1, wherein the bracing element includes a bracing element linkage and the lifting device includes a carrying element connected to at least one of the traveling crab and the load carrier and a carrying element linkage, and
wherein at least one of the bracing element linkage and the carrying element linkage includes a fixing elements having at least one of a hook, a loop, a lug, a deflection roller, a deflection holder and a deflection lug.

12: The system recited in claim 1, wherein the bracing device includes a tightening device and the lifting device includes a height-adjusting device, and
wherein at least one of the tightening device and the height-adjusting device includes a hoist or a winch.

13: The system recited in claim 1, wherein at least one of the bracing device and the lifting device includes a drive in the form of a motor.

14: The system recited in claim 13, wherein the bracing device includes a bracing element, and
wherein the drive is controllable so as to keep the bracing element tightened during operation of the system including movement of the load carrier.

15: The system recited in claim 13, wherein the drive is controllable so as to adjust a distance between the traveling crab and the load carrier.

16: The system recited in claim 1, wherein the bracing device includes a first bracing element and a second bracing element, the first and second bracing elements being configured to subject the load carrier to corresponding first and second bracing forces, and
wherein an angle defined by a horizontal component of a vector of the first bracing force and a horizontal component of a vector of the second bracing force is more than 90°.

17: The system recited in claim 1, wherein the bracing device includes first, second and third bracing elements configured to subject the load carrier to corresponding first, second and third bracing forces, and
wherein an angle defined by a horizontal component of a vector of the first bracing force and horizontal components of vectors of each of the second and third bracing forces is more than 90°.

18: The system recited in claim 1, wherein the bracing device includes first, second third and fourth bracing elements configured to subject the load carrier to corresponding first, second, third and fourth bracing forces, and
wherein an angle defined by horizontal components of vectors of each of the first and second bracing forces and horizontal components of vectors of each of the third and fourth bracing forces is more than 90°.

19: The system recited in claim 1, wherein the running rail is a first running rail, and wherein the system includes a second running rail, the load carrier being disposed underneath the first running rail and above the second running rail, the second running rail including a runner,
wherein the bracing device is connected to the runner, and
wherein the runner is always underneath the traveling crab during operation of the system.

20: The system recited in claim 1, wherein the lifting device includes at least two carrying elements, each carrying element associated with a height-adjusting device and a carrying element linkage.
